(19) United States
(12) Patent Application Publication
(10) Pub. No.: US 2021/0094048 A1
(43) Pub. Date: Apr. 1, 2021

(54) COMPACT FLUID NOZZLE FOR SPRAYING AND CLEANING APPLICATIONS HAVING A KEYSTONE-SHAPED SPRAY PATTERN

(71) Applicant: DLHBOWLES, INC., Canton, OH (US)

(72) Inventors: Russell Hester, Odenton, MD (US); Zachary Kline, Burtonsville, MD (US); Chunling Zhao, Columbia, MD (US)

(21) Appl. No.: 17/034,729

(22) Filed: Sep. 28, 2020

Related U.S. Application Data
(60) Provisional application No. 62/906,200, filed on Sep. 26, 2019.

(51) Int. Cl. B05B 1/04; B08B 3/02; B08B 3/04; B08B 13/00; B60S 1/56; B60S 1/52; B60S 1/54

(52) U.S. Cl. CPC B05B 1/04; B08B 3/02; B08B 3/04; G01S 2007/4043; B60S 1/56; B60S 1/52; B60S 1/54; B08B 13/00

(57) ABSTRACT

The disclosure relates to various fluid nozzles possessing the ability to produce a keystone-shaped spray pattern. In one embodiment, the present disclosure relates to one or more fluid nozzles that are able to produce a keystone-shaped spray pattern. In another embodiment, the present disclosure relates to two or more fluid nozzles that are able to be stitched together to produce a keystone-shaped spray pattern. In still another embodiment, the fluid nozzle, or nozzles, of the present disclosure are able to produce a desired spray pattern at low flow rates.

### CROSS REFERENCE TO RELATED APPLICATIONS

This application claims priority to U.S. Provisional Patent Application No. 62/906,200 entitled “COMPACT FLUID NOZZLE FOR SPRAYING AND CLEANING APPLICATIONS HAVING A KEYSTONE-SHAPED SPRAY PATTERN” filed on Sep. 26, 2019 which is hereby incorporated by reference in its entirety.

### FIELD OF THE DISCLOSURE

The disclosure relates to various fluid nozzles possessing the ability to produce a keystone-shaped spray pattern. In one embodiment, the present disclosure relates to one or more fluid nozzles that are able to produce a keystone-shaped spray pattern. In another embodiment, the disclosure relates two or more fluid nozzles with keystone-shaped spray cross-sections that can be arranged to produce an approximately rectangular impact pattern on a target surface. In still another embodiment, the fluid nozzle, or nozzles, of the present disclosure are able to produce a desired spray pattern at low flow rates.

### BACKGROUND OF THE DISCLOSURE

Some vehicles include external sensors, including external view (e.g., front bumper, side-view, rear-view or back-up) cameras to enhance the driver's vision and to improve safety. For example, rearview or “back-up” camera systems are integrated into vehicles to minimize the likelihood of “backovers.” A backover is a specifically-defined type of accident, in which a non-occupant of a vehicle (i.e., a pedestrian or cyclist) is struck by a vehicle moving in reverse. Vehicles can include other cameras to see into any other blind spot around a vehicle's periphery (behind, to the side, in front, above). All of these cameras can include exterior lens surfaces which will eventually become soiled with environmental debris.

Vehicles can include other sensors such as infrared image sensors that are incorporated to provide additional information to the driver or for autonomous driving. These vehicles may utilize sensors for object detection, location tracking, and control algorithms. Such vehicles may have different levels or types of automation, such as driver assistance systems, electronic power assist steering, lane keeping assistance, adaptive cruise control, adaptive steering, blind spot detection, parking assistance, traction, and brake control. The various types of automation rely on sensor input for their control and functionality.

These external sensors are exposed to the external environment and are often soiled by environmental debris, including mud, salt spray, dirt, grime, dust, water, or other debris. Accumulating debris can distort an image, deteriorate accuracy, or may render sensor output unusable. It is therefore desirable to clean these sensing devices to reduce or eliminate the buildup of obstructive debris.

Those in various automotive and transportation industries, as well as safety industries, have noticed that it is difficult to clean a surface, such as a LiDAR lens, from an incident angle or oblique position (not directly perpendicular). Additionally, in order to obtain full, nearly full, or substantially full coverage of the spray, and subsequent cleaning, of the targeted cleaning area on a sensor surface, current methods rely on either increasing the number of nozzles used, therefore increasing the overall cleaning coverage, or increasing the range of spray of the nozzles or the flow thereof, which increases the amount of overlap between spray output of multiple nozzles. Given this, there is a need in the art for a fluid spray nozzle, or nozzles, that are able to produce a suitable spray pattern for cleaning a lens, such as LiDAR lens, from an incident angle that is not perpendicular and/or that provides sufficient spray and cleaning coverage of the targeted area of the sensor surface.

### SUMMARY OF THE DISCLOSURE

The disclosure relates to various fluid nozzles possessing the ability to produce a keystone-shaped spray pattern. In one embodiment, the present disclosure relates to one or more fluid nozzles that are able to produce a keystone-shaped spray pattern. In another embodiment, the present disclosure relates to two or more fluid nozzles that are able to be stitched together to produce a keystone-shaped spray pattern. In still another embodiment, the fluid nozzle, or nozzles, of the present disclosure are able to produce a desired spray pattern at low flow rates.

In an embodiment, a sensor cleaning system is provided. The sensor cleaning system may comprise at least one fluid nozzle that selectively releases fluid spray onto a target surface. The at least one fluid nozzle may be configured to produce a key-stoned shape spray distribution pattern. The key-stone shape spray distribution pattern may comprise a perimeter shape that includes an upper spray portion and a lower spray portion. The upper spray portion may have a shorter width than the lower spray portion at the time the spray is distributed from the fluid nozzle. The key-stone shape spray distribution pattern may results in an orthogonal impact pattern on the target surface. The fluid nozzle may be configured to be positioned generally oblique to the target surface. The key-stoned shape spray distribution pattern may originate from an angle incident to a vertical axis of the target surface.

In an embodiment, the key-stone shape spray distribution pattern may include a top side, a left side, a bottom side opposite the top side, and a right side opposite the left side. The fluid spray at the top side may have the longest width of fluid spray when released from the fluid nozzle and may gradually taper toward the bottom side with the bottom side having the shortest width of fluid spray when released from the fluid nozzle. The key-stoned shape spray distribution pattern may have a cross-section arranged to provide the orthogonal impact pattern on the target surface. The key-stone shape spray distribution pattern may comprise a trapezoidal cross-section at a middle point of the distribution of the fluid spray from the fluid nozzle to the target surface. The key-stone shape spray distribution pattern may result in a rectangular impact pattern on the target surface.

In an embodiment, the sensor cleaning system may further comprise at least two fluid nozzles each configured to produce a key-stoned shape spray distribution pattern and each generating an orthogonal impact pattern on the target surface, wherein both orthogonal impact patterns may be positioned adjacent to one another and stitched together to provide a different, combined orthogonal impact pattern of the target surface. The key-stoned shape spray distribution pattern may prevent overspray beyond the target surface. The key-stoned shape spray distribution pattern may prevent overlapping spray on the target surface. The key-stoned shape spray distribution pattern may provide a perimeter impact zone that covers all or the majority of the target surface without leaving any large areas of the target surface un-impacted by the spray of fluid. The key-stoned shape spray distribution pattern may prevent unequal distribution of spray across the target surface. The key-stoned shape spray distribution pattern may provide equal spray density of the fluid spray across the target surface. The at least one fluid nozzle may produce the key-stoned shape spray distribution pattern at low flow rates. The target surface may be a surface of a lens of sensor in a vehicle sensor cleaning system.

In an embodiment, a spray distribution system configured to clean at least one sensor mounted to a vehicle is provided. The spray distribution system may comprise at least one fluid nozzle that selectively releases fluid spray onto a target surface. The at least one fluid nozzle may be configured to produce a key-stoned shape spray distribution pattern. The key-stone shape spray distribution pattern may comprise a perimeter shape that includes a top side, a left side, a bottom side opposite the top side, and a right side opposite the left side. The fluid spray at the top side may include a width of fluid spray that is longer than a width of fluid spray along the bottom side when released from the fluid nozzle. The key-stoned shape spray distribution pattern may prevent at least one of: overspray beyond the target surface, overlapping spray on the target surface, areas of the target surface not reached by spray, and unequal distribution of spray across the target surface.

In an embodiment, the fluid nozzle may not be perpendicular to a vertical axis of the target surface. The fluid nozzle may be oblique to the target surface. The key-stoned shape spray distribution pattern may originate from an angle incident to the vertical axis of the target surface. The angle of origination of the key-stoned shape spray distribution pattern may be between 15° and 30° relative the vertical axis of the target surface. The key-stoned shape spray distribution pattern may have a cross-section arranged to provide an orthogonal impact pattern on the target surface. The key-stone shape spray distribution pattern may comprise a trapezoidal cross-section at a middle point of the distribution of the fluid spray from the fluid nozzle to the target surface. The key-stone shape spray distribution pattern may result in a rectangular impact pattern on the target surface.

It is noted that any of the above mentioned aspects may be combined in any manner or in any way to provide a sensor cleaning system or spray distribution system without departing from the scope of the present teachings.

### BRIEF DESCRIPTION OF THE DRAWINGS

The present teachings may be better understood by reference to the following detailed description taken in connection with the following illustrations, wherein:

FIG. 1 is an schematic top view of vehicle sensor cleaning system and vehicle in accordance with various disclosed aspects;

FIG. 2 illustrates a traditional spray pattern having two sprays applied to a lens or sensor surface that leaves areas of lens or sensor without an spray impact;

FIG. 3 illustrates a traditional spray pattern having two sprays applied to a lens or sensor surface that results in overlapping or overspray areas;

FIG. 4 illustrates an embodiment of a spray pattern of the disclosure having two sprays applied to a lens or sensor surface;

FIG. 5 illustrates an embodiment of an spray distribution from a head-on position;

FIG. 6 illustrates an embodiment of a spray and spray distribution from an oblique position;

FIG. 7 illustrates a side view of the spray and spray distribution of FIG. 6;

FIG. 8 illustrates an embodiment of a spray distribution by a keystone-shaped spray from a head-on position; and

FIG. 9 illustrates an embodiment of a spray distribution by a keystone-shaped spray at an oblique angle.

### DETAILED DESCRIPTION OF THE DISCLOSURE

Reference will now be made in detail to embodiments of the present teachings, examples of which are illustrated in the accompanying drawings. It is to be understood that other embodiments may be utilized and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggests otherwise.

“Logic” refers to any information and/or data that may be applied to direct the operation of a processor. Logic may be formed from instruction signals stored in a memory (e.g., a non-transitory memory). Software is one example of logic. In another aspect, logic may include hardware, alone or in combination with software. For instance, logic may include digital and/or analog hardware circuits, such as hardware circuits comprising logical gates (e.g., AND, OR, XOR, NAND, NOR, and other logical operations). Furthermore, logic may be programmed and/or include aspects of various devices and is not limited to a single device.

As used herein, an external sensor generally refers to a device exposed to an external environment of a vehicle to sense driving conditions, environmental conditions, or the general surroundings of the vehicle. Such external sensors may include visual light sensors or cameras (e.g., charge-coupled device, complementary metal-oxide semiconductor devices, etc.), radio detection and ranging (radar) sensors, light direction and ranging (LiDAR) sensors, and other types of sensors. Such sensors may be utilized to assist users in operation of a vehicle (e.g., blind spot monitoring, backup cameras, etc.). In another aspect, external sensors may be utilized for driverless or autonomous vehicles. Moreover, embodiments may refer to external sensors as exposed to an external environment where the external sensor may be disposed in a housing with a lens or other shielding device separating the external sensor from direct contact with the environment. As such, the lens may be considered a portion of the external sensor that is exposed to the external environment. Examples of various nozzle assemblies and systems contemplated for cleaning lens or sensor surfaces along the exterior of a vehicle are know at least by the following commonly owned U.S. Pat. Nos. 10,432,827; 10,350,647; 10,525,937; and 10,328,906 each of which are incorporated by reference in their entireties.

Described embodiments generally relate to a vehicle sensor cleaning system or fluid nozzle used in spraying and cleaning applications. A vehicle sensor cleaning system may automatically or autonomously (e.g., without user actuation) clean one or more external sensors based on an algorithm. The algorithm may determine cleaning parameters based on operating parameters associated with operation of the vehicle, an external environment, or stored preferences. For instance, the vehicle sensor cleaning system may utilize available data from the vehicle and other sources to clean sensors at operative times in an appropriate way. Sensors to be cleaned may be prioritized under which circumstances. Moreover, vehicle sensor cleaning systems may control cleaning processes to conserve cleaning fluid or power. As such, aspects disclosed related to the cleaning of the sensors herein may improve safety, accuracy of sensors, and environmental impacts associated with reduced use of cleaning solutions.

Both fully Autonomous Vehicles (Level 4 & 5) and vehicles that have driver assistance systems (ADAS—Level 1-3) that utilize sensors which may be cleaned by described embodiments for improved safety, reliability and function. As vehicles are exposed to debris and other environmental factors (e.g., temperature, etc.), the differing environmental conditions, vehicular situations, vehicle hardware and debris types are a few examples of real world variables or operating parameters that may be utilized by disclosed embodiments to determine an effective time to clean, method of cleaning, cleaning duration, type of fluid (types of liquid or air) or other parameters of a cleaning event. The described vehicle sensor cleaning systems may remove chances for human error and may result in more efficient cleaning.

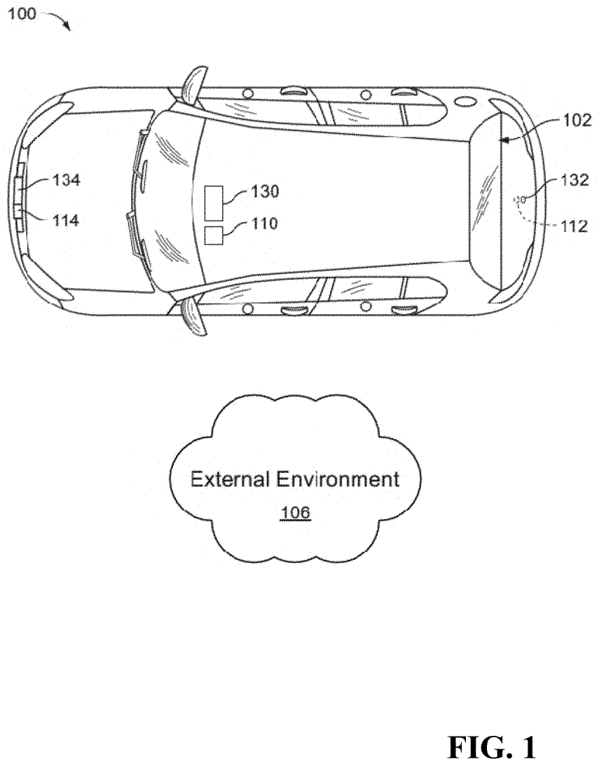

Turning to FIG. 1, there is an exemplary environmental view of a vehicle sensor cleaning system 100 for a vehicle 102. The vehicle sensor cleaning system 100 may include a processor, a memory, cleaning system sensors, cleaning devices, and user interface(s). It is noted that memory may store computer executable instructions or logic which may be executed by processor. In an aspect, executed instructions may control or instruct the various components described herein. It is noted that the vehicle sensor cleaning system 100 may include similar aspects as described with reference to the other figures and the various disclosed embodiments.

The vehicle sensor cleaning system 100 may include external sensors 130, 132, 134 and associated cleaning devices 110, 112, and 114, respectively. A processor may be disposed in the vehicle 102, such as in a dashboard or control panel of the vehicle 102. The various external sensors 130, 132, 134 and cleaning devices 110, 112, and 114 may be located at different positions (e.g., front, back, top, side, etc.) on or within the vehicle 102 and may comprise different orientations (e.g., rear facing, front facing, side facing etc.). Moreover, the various external sensors 130, 132, 134 and cleaning devices 110, 112, and 114 may comprise different attributes, such as types of sensors, types of cleaning devices, makes or models of sensors or cleaning devices, or the like. The processor may utilize the attributes to determine parameters for a cleaning event in conjunction with information about an external environment 106. For instance, different cleaning devices 110, 112, and 114 may comprise different capabilities or may be connected to different types of cleaning solutions, fluids, or gases (such as pressurized air). Moreover, different external sensors 130, 132, 134 may require different cleaning solutions, spray patterns, times of spray, pressure, or other parameter. The processor may utilize such information to determine intelligent parameters for a cleaning event.

The processor may receive input from cleaning system sensors, external sensors, or input from other sources, such as a smartphone or GPS unit, a vehicle, or other sources. The processor may utilize the input to determine when to execute and execute a cleaning process. The processor may receive information regarding ambient temperature (external to the vehicle), weather conditions (e.g. rain, clear, snow, etc.), location (e.g., based on GPS, Wi-Fi networks, triangulation, etc.), road conditions or expected road conditions, sensor types, sensor lens sizes and coating, vehicle speed, type of debris on sensor lens (e.g. mud, road spray, bugs, etc.), current outputs or items detected by cleaning system sensors or external sensors (signal strength or object classification), or other types of information. The processor may utilize some or all of this information to determine parameters for a cleaning process, such as cleaning fluid temperature, cleaning type and solution, cleaning duration, cleaning flow rates, cleaning pressures, any delayed cleaning, or other parameters.

The cleaning system sensors may include temperature sensors, pressure sensors, wind speed sensors, tire speed sensors, light sensors, accelerometers, gyroscopes, or other devices. For example, an accelerometer may be utilized to determine road conditions (e.g., bumpy, smooth, uphill, downhill, etc.), a vehicle direction of travel (e.g., forward, reverse, etc.), vehicle speed, or other parameter. In other examples, the cleaning system sensors may determine operating conditions such as vehicle speed, vehicle weight, brake conditions, or road conditions.

This disclosure relates to various cleaning devices possessing the ability to produce a specifically shaped spray pattern configured to impact a greater portion of a surface of a sensor or lens surface than prior known nozzles. In an embodiment, the cleaning devices are fluid nozzles that are configured to produce a keystone-shaped spray pattern. In one embodiment, the present disclosure relates to one or more fluid nozzles that are able to produce and/or generate a keystone-shaped spray pattern. In an example, the one or more fluid nozzles may produce and/or generate a spray pattern having a “keystone-shaped” spray pattern. The term “keystone-shaped” herein refers to a spray pattern having a generally trapezoidal shaped cross-section as will be described more fully herein. In another embodiment, the disclosure relates two or more fluid nozzles with keystone-shaped spray cross-sections that can be arranged to produce an approximately rectangular impact pattern on a target surface. In an example, the two or more fluid nozzles may produce and/or generate a spray pattern having a “keystone-shaped” trapezoidal cross-section through the ability of such two or more fluid nozzles being “stitched” or combined together. In still another embodiment, the fluid nozzle, or nozzles, of the present disclosure are able to produce a desired spray pattern at low flow rates.

In an embodiment, the fluid nozzle, or nozzles, of the present disclosure may comprise one or more X-Factor nozzles, where the use of the 3D spray permits the output pattern of the final fluid assembly of the one or more nozzles, or even the two or more nozzles, to be tailored to provide any desired spray pattern (e.g., a keystone-shaped spray pattern, trapezoidal cross-section, etc.) to one or more various surfaces, including flat, cylindrical, spherical or even freeform to achieve an orthogonal coverage area on a curved lens surface. In the case where multiple nozzles are used then any desired number of spray patterns, such as one, two, three, four, five, six, etc. spray patterns from any number of nozzles, such as one, two, three, four, five, six, etc. nozzles, can be “stitched” together to further optimize nozzle count, fluid consumption and cleaning performance. The nozzle may be positioned in an oblique mounting positions so as to avoid being in the sensor's vision “cone.” The resulting flow nozzles and corresponding spray disclosed herein may eliminate, decrease, or minimize wasteful spray usage, reduce overlap, or prevent leaving areas un-impacted by a fluid spray due to curvature of lens or spray output geometry.

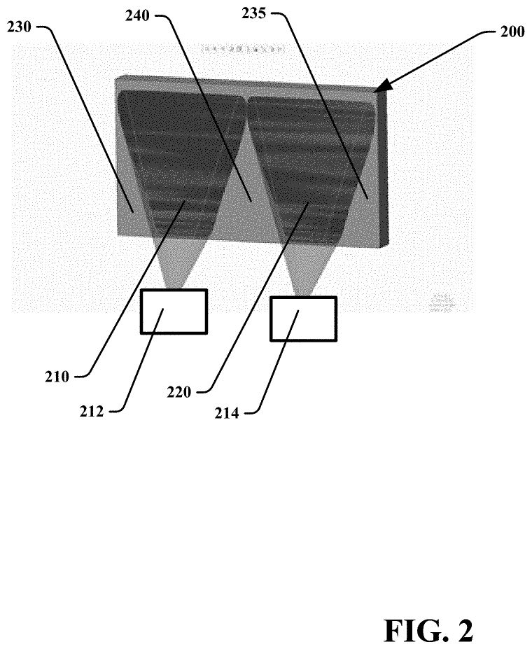

In comparison, FIG. 2 illustrates a traditional spray pattern from a fluid nozzle 212 or cleaning device. Illustrated is a first spray 210 distributed by a first fluid nozzle 212 and a second spray 220 distributed by a second fluid nozzle 214, applied to a lens or sensor surface 200 from an incident angle that is not directly perpendicular to the lens or sensor surface 200. Here, portions of the lens or sensor surface 200 remain outside the range of the first spray 210 and the second spray 220 and are not impacted by the initial spray pattern from the fluid nozzle. See, for example, un-impacted areas 230, 235, and 240. In particular, the traditional spray geometry shown in FIG. 2 may generate asymmetrical cleaning patterns for each the first spray 210 and the second spray 220 on the surface of the lens or sensor surface 200 creating no overlap or overspray may leave large sections at bottom of target dry. In FIG. 2, the asymmetrical cleaning patterns for each the first spray 210 and the second spray 220 are shown as a triangular shape having a wider end that tapers into a more narrow end.

Due to this shape and asymmetry of each the first spray 210 and the second spray 220, a wedge or triangular shaped un-impacted area 240 is between the sprays 210, 220 and triangular shaped un-impacted areas 230, 235 are on either side of the sprays 210, 220. As sprays may be performed during vehicle in portion, the un-impacted areas 230, 235, and 240 may not even receive run-off from the initial impact of the spray and may remain dry as they are outside of the range of the first spray 210 and the second spray 220 while the vehicle may be in motion. It is noted that other asymmetrical cleaning patterns other than that shown in FIG. 2 also exist that may leave portions of the lens or sensor surface 200 un-impacted, dry, or otherwise uncleaned. These areas 230, 235, 240 may remain uncleaned regardless of the number of times the first spray 210 and the second spray 220 are used, or based on the duration of the first spray 210 and the second spray 220, etc. These missed areas 230, 235, 240 remaining outside of the first spray 210 and the second spray 220 are likely to remain uncleaned and can be a frequent issue with traditional fanning or distributed sprays. Such traditional spray pattern in FIG. 2 results in a reduced cleaning efficacy of the lens or sensor surface 200 which may be undesirable and impede or impair use or functionality of the sensors and system. Notably, this issue may exist with a single fluid nozzle or cleaning device as well as a system that incorporates two or more fluid nozzles for spraying a common surface as illustrated by FIG. 2.

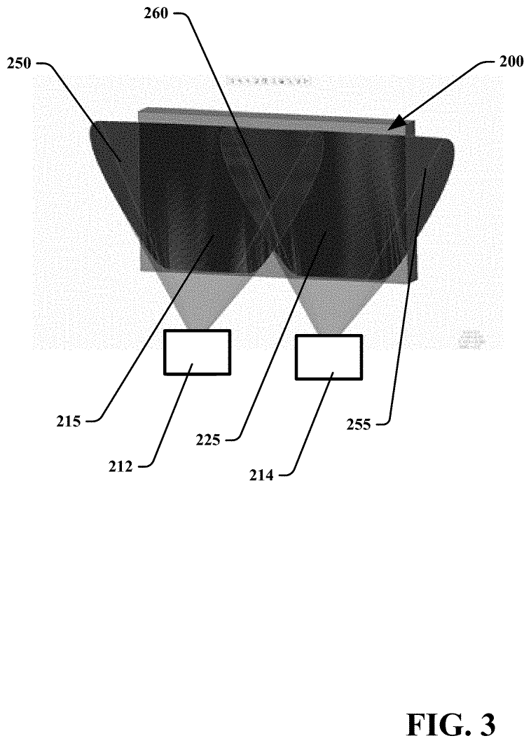

FIG. 3 illustrates a traditional spray pattern, including a first spray 215 distributed by a first nozzle 212 and a second spray 225 distributed by a second nozzle 214, applied to a lens or sensor surface 200 from an incident angle that is not directly perpendicular to the lens or sensor surface 200 and configured to avoid the un-impacted areas present in FIG. 2. In an embodiment, the range of the first spray 215 and the second spray 225, or the flow rate of either, may be broadened so that more of the lens or sensor surface 200 is impacted by the first spray 215 and the second spray 225 and less or no areas are left un-impacted. In an embodiment, a larger degree fan compared to that in FIG. 2, such as a 70 degree fan, for example, resulting in no large sections of the target left dry may instead create overlap or overspray. In the spray pattern shown in FIG. 3, a threshold degree fan, such as a 70 degree fan (while the first 210 and second sprays 220 of FIG. 2 may be about 40 degrees), may be required to establish sufficient bottom coverage thereby resulting in undesired overspray and overlap. In particular, the traditional spray geometry shown in FIG. 3 generates asymmetrical cleaning patterns for each the first spray 210 and the second spray 220 on the surface of the lens or sensor surface 200. In FIG. 3, the asymmetrical cleaning patterns for each the first spray 210 and the second spray 220 are shown as a triangular shape having a wider end that tapers into a more narrow end towards the first and second nozzles 212, 214. These asymmetrical cleaning patterns for each the first spray 210 and the second spray 220 in FIG. 3 are larger in size that the same shown in FIG. 2 to facilitate cleaning of the entire lens or sensor surface 200 and avoid missed areas 230, 235, 240 in FIG. 2.

This traditional spray pattern, however, does not address the actual shape of the first spray 215 and the second spray 225 and, as a result, the spray results in overlapping or overspray areas, see areas, 250, 255, 260. These overlapping areas may include an area 260 in the middle or in between the first spray 215 and the second spray 225 that receives spray from both the first spray 215 and the second spray 225. These overspray areas may include areas 250, 255 on either side of the first spray 215 and the second spray that extend beyond the edge of the lens or sensor surface 200. It is noted that other asymmetrical cleaning patterns other than that shown in FIG. 3 also exist that may result in portions of the lens or sensor surface 200 receiving overlapping or double the spray and portions of the spray that extend beyond the edge of the lens or sensor surface 200. These areas 250, 255, 260 may result in excess use of spray (overlapping or overspray areas) regardless of the number of times the first spray 210 and the second spray 220 are used, how long the first spray 210 and the second spray 220 are, etc.

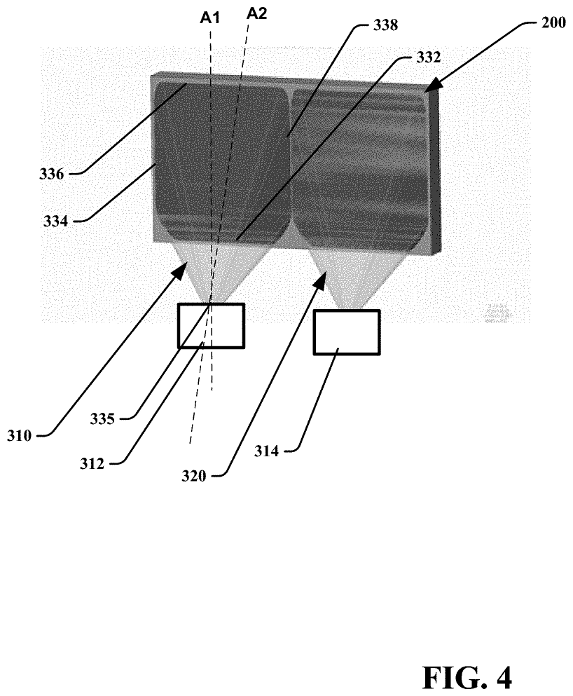

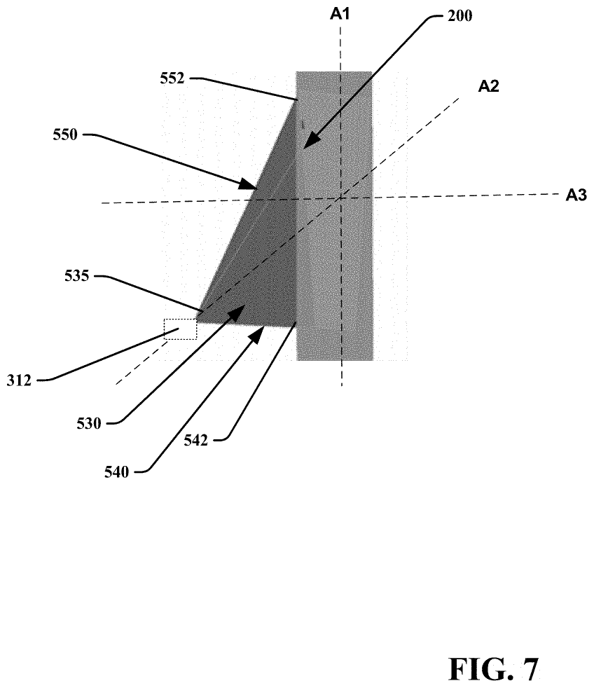

Moreover, any attempts to reduce the overlapping or overspray areas would result in the pattern shown in FIG. 2 where areas of the lens or sensor surface 200 are missed entirely. This is because the traditional patterns utilize asymmetrical patterns that cannot target the entire the lens or sensor surface 200 uniformly. These in overlapping or overspray areas 250, 255, 260 are likely to result in excess spray and fluid usage (e.g. higher consumption and waste of washer fluid) than is needed to efficiently clean the lens or sensor surface 200 and can be frequent issue with traditional fanning or distributed sprays. Such traditional spray pattern in FIG. 3 results in excess spray and fluid usage which may be undesirable, costly, and may cause insufficient fluid availability for future cleanings. Turning to FIG. 4, an embodiment of the present disclosure is shown. In an embodiment, the spray pattern in FIG. 4 includes at a first fluid nozzle 312 and a second fluid nozzle 314, corresponding to at least a first spray 310 and a second spray 320, that produce a spray pattern. Notably, this disclosure contemplates a system, assembly, or method that incorporates any number of nozzles and sprays and is not limited to two nozzles and sprays as illustrated by FIG. 4. In an embodiment, the first spray 310 and the second spray 320 may produce a “keystone-shaped” spray pattern, that, in contrast to the spray patterns shown in FIGS. 2-3, permits full, uniform coverage on the lens or sensor surface 200 despite the location or packaging of the nozzle, such as from an incident angle that is not directly perpendicular to the lens or sensor surface 200 (i.e. that is oblique to said lens or sensor surface 200). Additionally, the lens or sensor surface 200 may follow vertical axis A1 shown relative to the first spray 310 in FIG. 4 (a side view of the axes A1, A2, A3 is also shown in FIG. 7), where the fluid nozzle 312 is positioned at an oblique angle to the lens or sensor surface 200 and the origination of spray 335, 535 and line of impact follows generally axis A2. Axis A2 is shown in a position not perpendicular to the lens or sensor surface 200 (as shown by axis A3 in FIG. 7) so that the spray is thereby angled relative the lens or sensor surface 200. Axis A2 may comprise any angle less than or greater than the perpendicular axis A3.

Reasons for an oblique positioning of the nozzle, compared to perpendicular positioning, relative the lens or sensor surface 200, may include: the nozzle not being in the lens's or sensor's vision cone or primary field of vision during operation of the lens or sensor, the lens or sensor is not obstructed by the nozzle and support structures, ease of in-vehicle mounting and supply of pressurized fluid to the nozzle. Additionally on curved target surfaces, “falling off” of the spray from the surface combined with a wider effective spray at the top, may result in unwanted overspray and cross contamination of adjacent surfaces.

In one embodiment as illustrated by FIG. 4, the “keystone-shaped” spray pattern may produce a rectangular spray pattern on the lens or sensor surface 200 and may include a first side 332, second side 334, third side 336, and fourth side 338, where the first side 332 and third side 336 are opposite and parallel relative to one another and the second side 334 and fourth side 338 are opposite and parallel relative to one another. This “keystone-shaped” spray pattern can produce the most impacted area of the lens or sensor surface 200 using a spray from an incident angle (not directly perpendicular to the lens or sensor surface 200), while avoiding shortcomings of the spray pattern in FIG. 2 (missed areas), with the same amount of fluid dispensed during the spray event as the setup in FIG. 2 (i.e., without requiring additional fluid or fluid flow), and avoiding shortcomings of the spray pattern in FIG. 3 (overlapping and overspray).

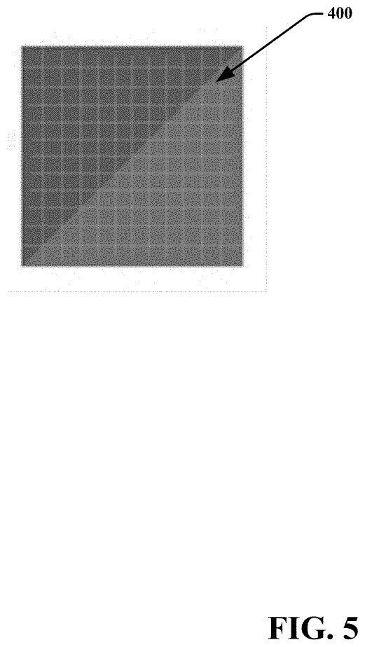

When considering what the spray density on an impacted surface might be in the oblique nozzle mounting location, there may also exist a need for a more tightly controlled spray or a more consistent or equal spray distribution, rather than or in addition to a keystone-shaped spray, to obtain desired spray patterns for cleaning a lens or sensor surface. For example, for a head-on X-factor nozzle output (see, e.g., U.S. Pat. No. 7,014,131 which is incorporated by reference in its entirety), if the spray is divided it up into, for example, 5 degree wedges in both X and Y directions, an image like that of FIG. 5 may result. FIG. 5 shows uniformly sized and consequently uniform area grids 400 where the following variables are utilized: Q=flow rate (e.g., in mL/min); A=area of the impacted zone; Agrid=area of individual grid; and t=spray duration. In assuming that a “perfect” spray has a 100% uniform distribution, then each impacted grid would have a spray volume of ((Qtotal*t)/(Atotal)*Agrid. The result, in this head on impact, would be that each grid would get a uniform distribution of fluid deposited (this could be measured in mL, for example, or any other suitable measurement for defining fluids). In other words, each grid square, which is equal due to the positioning of the spray at a perpendicular or head-on angle, corresponds to an equal surface area of the target and thereby an equal density of fluid distributed.

Taking and applying this rationale to the same spray, but at an oblique angle rather than a head-on angle, it may be understood that it would have the same spray distribution (100%) and same grid structure 400 as in FIG. 5 when a slice is taken normal to the center axis, but create a much different impact distribution on the target surface (because the spray is not directly perpendicular to the target surface). The present disclosure may be used to overcome this non-uniform impact distribution of a spray on a target surface even when at an oblique angle.

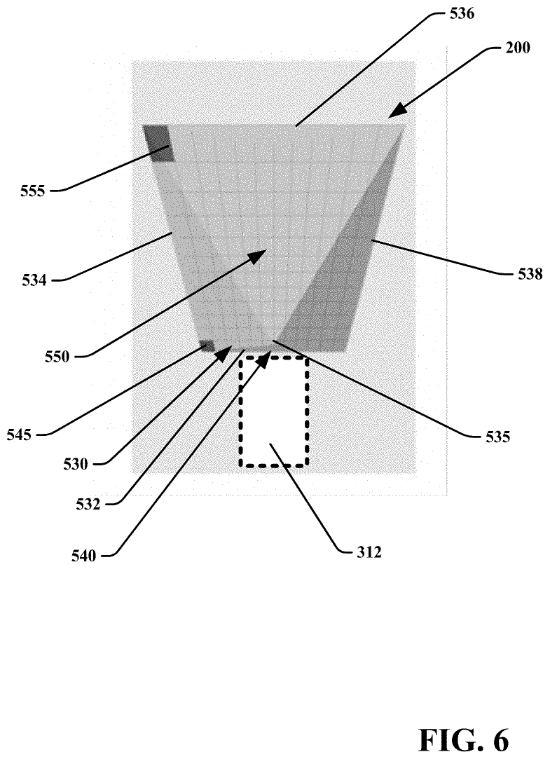

Turning to FIGS. 6-7, FIG. 6 is a nozzle and FIG. 7 is a side view of the nozzle of FIG. 6 positioned so that the spray 500 is at an angle of approximately 23 degree oblique (shown by axis A2) to the target (having a vertical axis A1 and an exemplary perpendicular axis A3) and rotated slightly to show “flight time” (where flight time=distance to target/impact surface). Although FIGS. 6-7 show an approximate angle of 23 degree oblique to the target, it is noted that the disclosure is relevant to any degree oblique to the target, and includes a minimum range of 5 degrees to 85 degrees (or less than 90 degrees) to the target. It is also noted that the nozzle 312 and origination of the spray 535 may occur generally “below” the horizontal axis A3 showing a perpendicular angle from the lens or sensor surface 200, or generally “above” the horizontal axis A3, and be considered oblique or at an incident angle as described herein. FIGS. 6-7 illustrate how the shape of the originally square grid 400 in FIG. 5, having an equal distribution of spray from a directly perpendicular or head-on position to a target surface, has changed to an elongated rectangle, taking into account the oblique angle of the spray. The elongated rectangle shown in FIG. 6 includes a first side 532, second side 534, third side 536, and fourth side 538, where the first side 532 and third side 536 are opposite and parallel and the second side 534 and fourth side 538 are opposite and narrow or taper toward the bottom of the spray pattern. Such narrowing or tapering of the spray pattern due to the oblique positioning can result in missed areas or increased fluid flow to effectively clean the lens or sensor surface 200. FIGS. 6-7 show spray 530 originating from the same location 535 (e.g. from nozzle 312) at an oblique angle from target (such as lens or sensor surface 200), traveling along its designated flight path by a line of impact 552. As can be seen from FIGS. 6-7, the bottom of the spray, and those corresponding droplets may have a shorter flight time 540 than those at the top of the spray having a longer flight time 550. This difference in flight time is because the nature of the oblique angle positions part of the spray (in FIGS. 6-7, it is the bottom of the spray 540) closer to the target and part of the spray (in FIGS. 6-7, it is the top of the spray 550) further from the target so that the line of impact 552 of the spray pattern toward the third side 536 of the spray pattern is longer or has a greater distance to the lens or sensor surface 200 as compared to the line of impact 542 of the spray pattern toward the first side 532 of the spray pattern, which is shorter or has less of a distance to the lens or sensor surface 200.

This extra “time” is what produces and achieves the elongated grid on the impact surface seen in FIG. 6, which is different from the equally distributed grid of FIG. 5. In this specific example (geometry dependent) in FIGS. 6-7, the bottom left square 545 has nearly 5 times smaller surface area than the top left square 555. The surface area in each grid square may vary widely over the whole target surface as shown in FIG. 6, and may generally resemble a gradient from top to bottom. The particular gradient is dependent on the location of the origination of the spray 535 and the angle thereof compared to the target. For example, the gradient could be more dense at the bottom, more dense at the top, more dense at the right side or the left side, etc. moving to a lesser gradient at the opposite area of the target.

As a result, the density of fluid, as defined by Q*t (delivered to each grid)/Agrid will be significantly different, again in this example, 5 times less dense in the upper left corner 555 compared to the lower left corner 545. This variation per grid is evident in FIGS. 6-7 based on the grid size showing surface area. A larger surface area, or larger grid squares, may indicate a lesser density of fluid as the same volume or amount of fluid is used to contact the area as the smaller surface areas, or smaller grid squares, which may indicate a greater density of fluid for the same reason. Couple this density variation, with the overspray, overlapping spray, and/or missed spray to the target area described earlier, and it is apparent that the spray pattern using, for example, one or more standard x-factor nozzles (see, e.g., U.S. Pat. No. 7,014,131, which is hereby incorporated herein by reference in its entirety), results in the problem of unequal distribution of spray on the target from an oblique angle.

Taking into consideration that there is an optimal amount of surface fluid density that affects good cleaning, in order to effectively clean the least dense grid, top left 555, one would need to massively over clean the bottom left grid 545 and with various decreasing levels clean the remaining grid as the spray travels up the surface. This would and does result in wasted wash fluid. The alternative is to clean the bottom left grid 545 with only the needed amount of fluid for that particular grid, which would result in massive under-cleaning of the top left grid 555 as various decreasing levels clean the remaining grid as the spray travels up the surface. As a result, it may be desirable to have a more equal distribution of fluid across the surface of the target to effectuate sufficient cleaning of the entire surface and to provide effective cleaning without waste or overconsumption of fluid

As will be discussed below a nozzle producing a keystone-shaped spray pattern solves the above shortcomings of not only the ability to cover the target surface without overspray, overlapping spray, or missed areas, as shown in FIG. 4 compared to FIGS. 2-3 and 6, but to also provide more equal distribution of fluid spray across the target surface from an oblique angle compared to that in FIG. 5 not from an oblique angle and FIGS. 6-7 showing unequal spray. In an embodiment, the resulting spray pattern is a spray pattern that is narrower at the top and wider at the bottom, and has a good distribution of droplets to maximize the cleaning potential of the spray. This may include a spray with a keystone-shaped trapezoidal cross-section. In doing so, once the spray impacts the surface of the target, it translates to an orthogonal shape which can be more easily matched to cleaning requirements of the sensor or to other packaging constraints. Additional nozzles and fluid sprays can be “stitched” together (e.g. placed near or adjacent one another to produce minimal overlap or missed areas) to further allow cleaning of the target surface and to optimize nozzle count, fluid consumption, and cleaning performance while minimizing wasteful spray overlap, overspray, and missed areas that would otherwise not be hit by the spray due to the curvature of the lens or sensor or geometric constraints of traditional fan sprays.

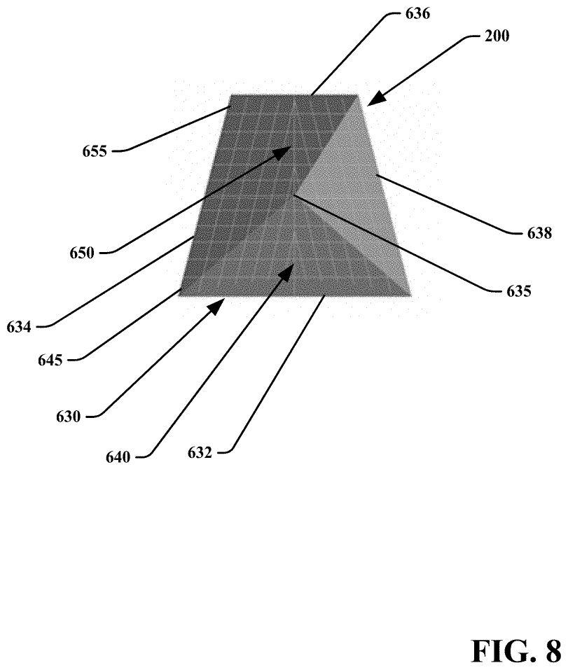

As illustrated in FIG. 8, the keystone-shaped head-on area, is hard to evenly divide as it is trapezoidal in shape and not a parallelogram. FIG. 8 shows spray 630 originating from the same location 635 (e.g. from a nozzle not shown) at a head-on angle from target (such as lens or sensor surface 200), traveling along its designated flight path. As can be seen from FIG. 8, the bottom of the spray, and those corresponding droplets may have the same flight time 640 as those at the top of the spray 650. As result, grid squares 645, 655 have the same surface area and fluid density.

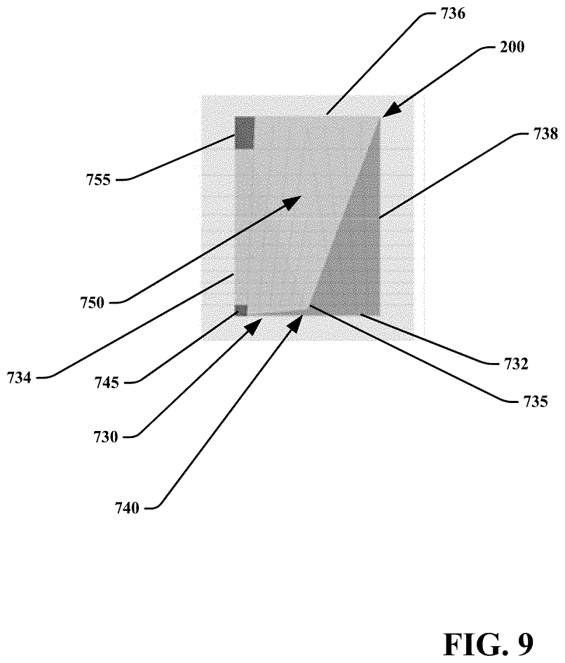

Take the image in FIG. 8 as one method at evenly dividing the area. In FIG. 9, a keystone-shaped spray at an oblique angle, with resulting grid elongation of the spray, similar to FIGS. 6-7 except now the key-stone shaped spray may be used to counteract the unequal spray pattern that was evident in FIG. 6-7. FIG. 9 shows spray 730 originating from the same location 735 (e.g. from a nozzle not shown) at an oblique angle from target (such as lens or sensor surface 200), traveling along its designated flight path. As can be seen from FIG. 9, the bottom of the spray, and those corresponding droplets may have a shorter flight time 740 than those at the top of the spray having a longer flight time 750. Nevertheless, grid squares 745, 755 have the same surface area and fluid density. FIG. 9 shows a rectangular spray pattern, including a first side 732, second side 734, third side 736, and fourth side 738, where the first side 732 and third side 736 are opposite and parallel and the second side 734 and fourth side 738 are opposite and parallel.

Given FIGS. 8-9, the keystone-shaped spray may eliminate or minimize the overspray to the target area shown in the standard x-factor in FIG. 7-8. One will see that “geometry” is still “geometry” and the grids elongate as demonstrated in the Standard x-factor figures. In this example, again dimensions dependent, the upper left hand resulting grid has a nearly 5 times larger impact area.

The only conclusion is that a “perfect” distributed spray is not always a perfect solution. Therefore, in one embodiment, the present disclosure uses the combination of a keystone-shaped spray and a deliberate distribution of flow rate/fluid density in the spray to result in the most uniform density possible on the target surface. This “efficiency” of spray has the following benefits. An efficient spray is one characterized by both a keystone-shaped output or any derivation to match target surface shape, and a deliberate distribution of fluid within the spray to compensate for fluid deposition on a target surface with as uniform a density as possible.

While not wishing to be bound to any one benefit, one or more of the following benefits may be achieved: the shaped spray avoids missing areas of the target surface; the shaped spray avoids overspray; the shaped spray avoids overlapping spray; a uniform spray distribution means is achieved, including and equal and optimized density of fluid per unit of surface area of the target; sufficient cleaning of the sensors to provide desired functionality and use in the overall system; less fluid is wasted fluid (that is there are less over cleaned high density areas in order to achieve a desired minimum level of cleaning in one or more low density areas); and/or potentially shorter duration cleaning cycles, meaning the sensor is performing its role for a longer time, less sensor blindness (both of the above could maximize the washer fluid reservoir's time-between-refills or minimize the size of a bottle to begin with).

Proposed Efficiency Co-efficient: [(Grid Density Max−Grid Density Min)]/[(Qtotal*t*(1/Target Area Total))], where Grid Density is the amount of fluid delivered to each grid divided by individual grid surface area; Q Total is the flow rate of the nozzle/s; t is the duration of the spray; and the target area total is the area of the entire targeted cleaning zone.

The deliberate distribution of fluid is, in one instance, important to make the keystone-shaped spray pattern work. The distribution function is dependent on the following variables: if the spray is an oscillator, Frequency of Spray, Dwell time and whipping velocity; Fluid Velocity (as it has a direct impact on droplet size), which is a function of pressure; and Droplet Size, which is a function of Pressure and Flow Rate. Careful manipulation of these variables will allow for the best co-efficient of efficiency.

It is contemplated that such a keystone-shaped spray may be made by a nozzle that includes a fluid oscillator. However, it is also contemplated that the keystone-shaped sprays may be generated by a nozzle having a shear spray orifice configuration.

Although the disclosure has been described with reference to certain embodiments detailed herein, other embodiments can achieve the same or similar results. Variations and modifications of the disclosure will be obvious to those skilled in the art and the disclosure is intended to cover all such modifications and equivalents.

What is claimed is:

1. A sensor cleaning system, comprising:
at least one fluid nozzle that selectively releases fluid spray onto a target surface,
wherein the at least one fluid nozzle is configured to produce a key-stoned shape spray distribution pattern;
wherein the key-stone shape spray distribution pattern comprises a perimeter shape that includes an upper spray portion and a lower spray portion, wherein the upper spray portion has a shorter width than the lower spray portion at the time the spray is distributed from the fluid nozzle and wherein the key-stone shape spray distribution pattern results in an orthogonal impact pattern on the target surface;
wherein the fluid nozzle is configured to be positioned generally oblique to the target surface and the key-stoned shape spray distribution pattern originates from an angle incident to a vertical axis of the target surface.

2. The sensor cleaning system of claim 1, wherein the key-stone shape spray distribution pattern includes a top side, a left side, a bottom side opposite the top side, and a right side opposite the left side, wherein the fluid spray at the top side has the longest width of fluid spray when released from the fluid nozzle and gradually tapers toward the bottom side with the bottom side having the shortest width of fluid spray when released from the fluid nozzle.

3. The sensor cleaning system of claim 1, wherein the key-stoned shape spray distribution pattern has a cross-section arranged to provide the orthogonal impact pattern on the target surface.

4. The sensor cleaning system of claim 1, wherein the key-stone shape spray distribution pattern comprises a trapezoidal cross-section at a middle point of the distribution of the fluid spray from the fluid nozzle to the target surface.

5. The sensor cleaning system of claim 1, wherein the key-stone shape spray distribution pattern results in a rectangular impact pattern on the target surface.

6. The sensor cleaning system of claim 1, further comprising at least two fluid nozzles each configured to produce a key-stoned shape spray distribution pattern and each generating an orthogonal impact pattern on the target surface, wherein both orthogonal impact patterns are positioned adjacent to one another and stitched together to provide a different, combined orthogonal impact pattern of the target surface.

7. The sensor cleaning system of claim 1, wherein the key-stoned shape spray distribution pattern prevents overspray beyond the target surface.

8. The sensor cleaning system of claim 1, wherein the key-stoned shape spray distribution pattern prevents overlapping spray on the target surface.

9. The sensor cleaning system of claim 1, wherein the key-stoned shape spray distribution pattern provides a perimeter impact zone that covers all or the majority of the target surface without leaving any large areas of the target surface un-impacted by the spray of fluid.

10. The sensor cleaning system of claim 1, wherein the key-stoned shape spray distribution pattern prevents unequal distribution of spray across the target surface.

11. The sensor cleaning system of claim 1, wherein the key-stoned shape spray distribution pattern provides equal spray density of the fluid spray across the target surface.

12. The sensor cleaning system of claim 1, wherein the at least one fluid nozzle produces the key-stoned shape spray distribution pattern at low flow rates.

13. The sensor cleaning system of claim 1, wherein the target surface is a surface of a lens of sensor in a vehicle sensor cleaning system.

14. A spray distribution system configured to clean at least one sensor mounted to a vehicle, comprising:
at least one fluid nozzle that selectively releases fluid spray onto a target surface,
wherein the at least one fluid nozzle is configured to produce a key-stoned shape spray distribution pattern;
wherein the key-stone shape spray distribution pattern comprises a perimeter shape that includes a top side, a left side, a bottom side opposite the top side, and a right side opposite the left side, wherein the fluid spray at the top side includes a width of fluid spray that is longer than a width of fluid spray along the bottom side when released from the fluid nozzle;
wherein the key-stoned shape spray distribution pattern prevents at least one of: overspray beyond the target surface, overlapping spray on the target surface, areas of the target surface not reached by spray, and unequal distribution of spray across the target surface.

15. The spray distribution system of claim 14, wherein the fluid nozzle is not perpendicular to a vertical axis of the target surface.

16. The spray distribution system of claim 15, wherein the fluid nozzle is oblique to the target surface and the key-stoned shape spray distribution pattern originates from an angle incident to the vertical axis of the target surface.

17. The spray distribution system of claim 15, wherein the angle of origination of the key-stoned shape spray distribution pattern is between 15° and 30° relative the vertical axis of the target surface.

18. The sensor cleaning system of claim 14, wherein the key-stoned shape spray distribution pattern has a cross-section arranged to provide an orthogonal impact pattern on the target surface.

19. The sensor cleaning system of claim 14, wherein the key-stone shape spray distribution pattern comprises a trapezoidal cross-section at a middle point of the distribution of the fluid spray from the fluid nozzle to the target surface.

20. The sensor cleaning system of claim 14, wherein the key-stone shape spray distribution pattern results in a rectangular impact pattern on the target surface.
